(19) United States
(12) Patent Application Publication
(10) Pub. No.: US 2025/0146987 A1
(43) Pub. Date: May 8, 2025

(54) FIRST-DIMENSION-GUIDED DIFFERENTIAL RESCALING OF CONTOUR PLOT IN COMPREHENSIVE TWO-DIMENSIONAL GAS CHROMATOGRAPHY

(71) Applicant: The Regents of The University of Michigan, Ann Arbor, MI (US)

(72) Inventors: Xudong FAN, Ann Arbor, MI (US); Wenzhe Zang, Ann Arbor, MI (US); Xiaheng Huang, Ann Arbor, MI (US); Ruchi Sharma, Ann Arbor, MI (US)

(73) Assignee: The Regents of The University of Michigan, Ann Arbor, MI (US)

(21) Appl. No.: 18/937,667

(22) Filed: Nov. 5, 2024

Related U.S. Application Data
(60) Provisional application No. 63/547,733, filed on Nov. 8, 2023.

(51) Int. Cl. G01N 30/86; G01N 30/02

(52) U.S. Cl. CPC G01N 30/8651; G01N 2030/025

(57) ABSTRACT

A first-dimension-guided differential scaling algorithm of the contour plot in comprehensive two-dimensional gas chromatography (2D GC) system is developed by incorporating both ¹D and ²D chromatograms obtained by first and second detectors. This differential scaling method is shown to significantly improve 2D GC results in terms of retention time accuracy and consistency, peak width and hence peak capacity, and analyte quantification accuracy, which are inevitably affected by the modulation period and phase shift in modulation when the conventional contour plot reconstruction methods. Furthermore, the differential scaling method is shown to better handle the coelution and missing peak issues often encountered in the conventional methods. Finally, the differential scaling method exhibits high versatility in detector selection, which greatly broadens the 2D GC utility and can be easily adapted to other 2D chromatography systems.

### CROSS-REFERENCE TO RELATED APPLICATIONS

This application claims the benefit and priority of U.S. Provisional Application No. 63/547,733 filed on Nov. 8, 2023. The entire disclosure of the above application is incorporated herein by reference.

### GOVERNMENT CLAUSE

This invention was made with government support under R01 OH011082 awarded by the Centers for Disease Control and Prevention, and FA8650-19-C-9101 awarded by the U.S. Air Force Research Laboratory. The government has certain rights in the invention.

### FIELD

The present disclosure relates to two-dimensional chromatography.

### BACKGROUND

With reference to FIG. 1A, comprehensive two-dimensional gas chromatography (GC×GC) uses two columns of different stationary phases so that vapor analytes are subjected to two independent separations to achieve a peak capacity higher than the corresponding one-dimensional gas chromatography (GC). A modulator is placed between a first separation column and a second separation column and periodically sends a portion of the eluent to the second separation column. Usually, a thermal modulator or pneumatic modulator are used to achieve so-called snapshot modulation and accumulative modulation, respectively.

In a conventional GC×GC system, only one detector is used at the end of the second separation column to detect the eluents coming out of the second separation column. A two-dimensional (2D) chromatogram is constructed, where the 2D chromatogram is directly measured by the second detector and the 1D chromatogram is reconstructed from a series of 2D chromatograms as well as the timing information provided by the modulator. There are a few major drawbacks in the conventional GC×GC system. First, there is a dilemma in modulation frequency (i.e., first sampling rate). On one hand, accurate reconstruction of the 1D chromatogram requires a shorter modulation time (i.e., a higher first sampling rate). On the other hand, 2D separation prefers to have a longer modulation time to improve separation and avoid a potential wrap-around issue. A long modulation time (i.e., a low first sampling rate) results in distorted peak profiles, additional peak broadening, inaccurate peak retention times, and missing peaks in first dimension, which in turn reduces the overall peak capacity for the GC×GC system and adversely affects peak identification and quantification. In addition, since the relative positions of the 1D peaks and the modulation time cannot be accurately controlled, a phase drift between the 1D peaks and the sampling time point may occur from run to run, which affects the repeatability in 1D chromatogram reconstruction.

This section provides background information related to the present disclosure which is not necessarily prior art.

### SUMMARY

This section provides a general summary of the disclosure, and is not a comprehensive disclosure of its full scope or all of its features.

A method for producing a two dimensional chromatogram is presented. The method includes: measuring, by a first detector, eluent exiting a first column of a chromatography system to form first eluent data; measuring, by a second detector, eluent exiting a second column of the chromatography system to form second eluent data, where the second column is downstream from the first column; modulating the eluent passing from the first column to the second column at a modulation frequency; partitioning the second eluent data into a plurality of data slices separated at time intervals according to the modulation frequency; scaling the second eluent data to form scaled second eluent data, where the second eluent data is scaled in part using the first eluent data; interpolating additional eluent data from the scaled second eluent data, where the additional eluent data is generated at time intervals less than time intervals specified by the modulation frequency; scaling the additional eluent data to form scaled additional eluent data, where the additional eluent data is scaled in part using the first eluent data; and generating a two dimensional chromatogram from the scaled second eluent data and the scaled additional eluent data.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a diagram depicting a conventional two-dimensional gas chromatography system.

FIG. 1B is a diagram depicting a two-dimensional gas chromatography system with an additional detector disposed between the first column and the second column.

FIG. 2A illustrates the conventional approach to producing a two dimensional chromatogram.

FIG. 2B illustrates the proposed first-dimension-guided differential scaling method for producing a two dimensional chromatogram.

FIG. 3 is a flowchart further illustrating the proposed first-dimension-guided differential scaling method.

FIG. 4 depicts artificially generated ¹D and ²D chromatograms with reconstructed contour plots using the conventional method and the new method, illustrating the influence of modulation time and phase shift. The dashed line and solid line represent the chromatograms along ¹D and ²D, respectively. The hashed bars mark the areas under the ¹D peaks during ¹D-to-²D loading sessions. The ¹D peak profiles are the same for all cases. Modulation time and phase shift are varied for ²D and loading times are kept the same for all cases.

FIGS. 5A-5C depict artificially generated ¹D and ²D chromatograms with ¹D coelution along with reconstructed contour plots using the conventional method and the proposed first-dimension-guided differential scaling method, respectively.

FIG. 6 depicts portions of exemplary chromatograms of an exhaled breath sample. (A-D) ¹D and ²D chromatograms. (E-H) ²D contour plots using the conventional method (only ²D data in (A-D)). (I-L) ²D contour plots using the new method (both ¹D and ²D data in (A-D)).

FIG. 7 depicts artificially generated ¹D and ²D chromatograms with different ¹D and ²D detector responsivity ratios and their corresponding reconstructed contour plots using the conventional method and the first-dimension-guided differential scaling method.

Corresponding reference numerals indicate corresponding parts throughout the several views of the drawings.

### DETAILED DESCRIPTION

Example embodiments will now be described more fully with reference to the accompanying drawings.

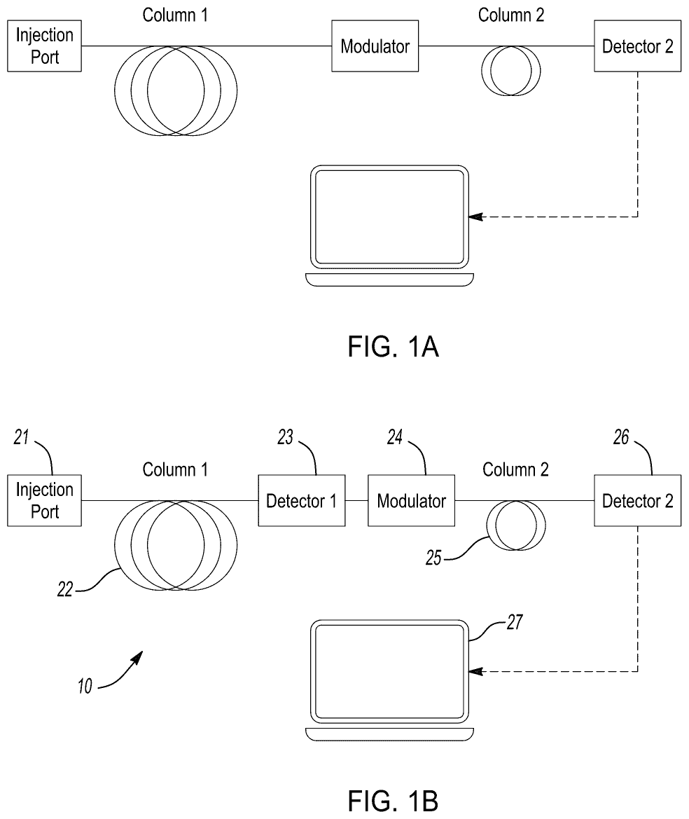

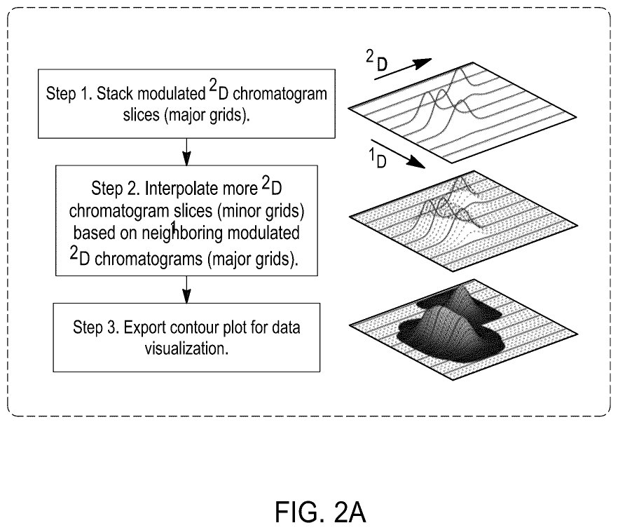

FIG. 1B depicts a new gas chromatography system 10. The gas chromatography system 10 is comprised of a first separation column 22 fluidly coupled to a second separation column 25. A gas sample may be injected in the system at an injection port 21. A first detector 23 is positioned at an outlet of the first separation column 22 and is configured to measure eluent exiting the first separation column 22. A second detector 26 is position at an outlet of the second separation column 25 and is configured to measure eluent exiting the second separation column 25. The eluent passing from the first separation column 22 to the second separation column 25 is modulated at a frequency controlled by a modulator 24. The first detector 23, the second detector 26 and the modulator 24 are interfaced with a controller 27. It is to be understood that only the relevant components of the system are discussed in relation to FIG. 1B, but that other components may be needed to control and manage the overall operation of the system.

In an exemplary embodiment, the controller 27 is implemented as a microcontroller. It should be understood that the logic for the control of system 10 by controller 27 can be implemented in hardware logic, software logic, or a combination of hardware and software logic. In this regard, controller 27 can be or can include any of a digital signal processor (DSP), microprocessor, microcontroller, or other programmable device which are programmed with software implementing the above described methods. It should be understood that alternatively the controller is or includes other logic devices, such as a Field Programmable Gate Array (FPGA), a complex programmable logic device (CPLD), or application specific integrated circuit (ASIC). When it is stated that controller 27 performs a function or is configured to perform a function, it should be understood that controller 27 is configured to do so with appropriate logic (such as in software, logic devices, or a combination thereof).

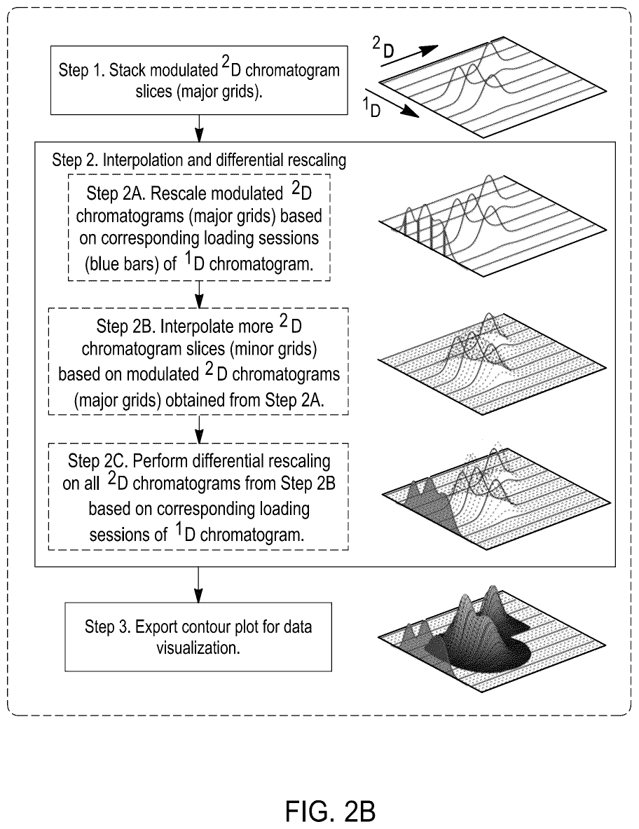

Referring to FIG. 2A, the conventional approach for obtaining a two-dimensional chromatogram is described. In Step 1, the output from the second detector 26 is sliced according to the modulation time, and each sliced ²D chromatogram is stacked side-by-side along the ¹D time axis with the major grids defined by the modulation time. In Step 2, the chromatogram is smoothed by interpolation of data points between the neighboring ²D chromatogram slices on the major grids along the ¹D axis to obtain a contour plot. In one example, the modified Akima piecewise cubic Hermite interpolation as implemented by the “interp2” command in MATLAB was used to avoid the overshooting problem found in the spline fitting. As a result, more ²D chromatogram slices are generated on the minor grids. The distance between the two minor grids depends on the data interpolation density and it usually ranges from 10 seconds to 0.001 seconds. In Step 3, all ²D chromatograms on both major and minor grids are merged as a whole group of ²D chromatograms and they can be exported as a contour plot for data visualization. The methods to export a series of ²D chromatograms into a contour plot are routinely used in gas chromatography data analysis and many software (such as MATLAB) have codes to perform this.

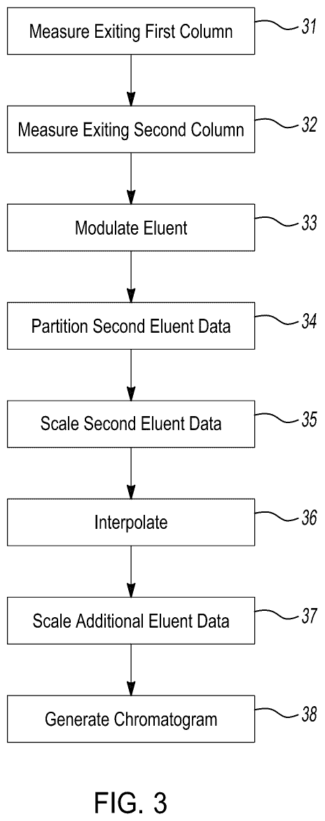

Referring to FIGS. 2B and 3, a proposed first-dimension-guided scaling method for two-dimensional chromatography is described. Similar to the conventional procedures, there are three major steps. Step 1 is the same as Step 1 in the conventional procedures described above.

During operation, first eluent data is collected at 31 by measuring the eluent exiting the first separation column 22 using the first detector 23 and second eluent data is collected 32 by measuring the eluent exiting the second separation column 25 using the second detector 26. The eluent passing from the first separation column 22 to the second separation column 25 is modulated at a modulation frequency by the modulator 24 as indicated at 33. In some embodiment, the modulation frequency or the sampling rate of the first detector 23 can vary piecewise. For example, in the first 100 seconds of the first-dimensional separation, the modulation frequency can be 1 Hz (i.e., a modulation period of one second); from 100 seconds to 300 seconds, the modulation frequency becomes 0.5 Hz (i.e., a modulation period of two seconds); and from 300 seconds and on, the modulation frequency becomes 0.25 Hz (i.e., the modulation period is 4 seconds). Although the modulation frequency (or period) is not constant throughout the first-dimensional separation, the proposed first-dimension-guided differential scaling method can still generate a ²D chromatogram.

To generate the chromatogram, the second eluent data is partitioned at 34 into a plurality of data slices at time intervals according to the modulation frequency. Each slice of the second eluent data is then stacked side-by-side at major grid intervals along the ¹D time axis, where the time intervals between grids is determined by the modulation frequency. This step is the same as the conventional approach.

Next, the second eluent data is rescaled in accordance with the first eluent data. More specifically, the second eluent data is scaled at 35 in part using the first eluent data to form scaled second eluent data. That is, Step 2A is to rescale the ²D chromatograms on the major grids based on the ¹D chromatogram. Due to mass conservation, each ²D chromatogram on the major grid in FIG. 2B is produced by part of ¹S(t) loaded into the ²D column in a modulation period. Therefore, for a ²D chromatogram, ²Sₙ(t), on a major grid at tₙ, where tₙ is the start time of the n^{th} modulation event, the total quantity of the analytes loaded into the ²D column is proportional to the area under ¹S(t) measured by the ¹D detector, within this modulation period, i.e.,

$${}^{1} {A}_{n} = {\int }_{{t}_{n}}^{{t}_{n} + {t}_{L}} {}^{1} S ( t ) dt , \qquad ( 1 )$$

where t_{L} is the ¹D-to-²D loading time. 0<t_{L}<P_{M} for modulators with a duty cycle of <1 (e.g., most pneumatic modulators) and t_{L}=P_{M} for ones with a 100% duty cycle (e.g., most thermal modulators). Similarly, assuming no wrap-around issue in ²D separation, the total quantity of analytes detected by the ²D detector should be proportional to the total area under ²Sₙ(t), i.e.,

$${}^{2} {A}_{n} = {\int }_{0}^{{P}_{M}} {}^{2} {S}_{n} ( t ) dt , \qquad ( 2 )$$

where ²Sₙ(t) is the ²D chromatogram measured by the ²D detector during the n^{th} modulation period. A rescaling factor, Rₙ, for this modulation period can be obtained as:

$${R}_{n} = \frac{{}^{1} {A}_{n}}{{}^{2} {A}_{n}} . \qquad ( 3 )$$

Due to mass conservation, ²Sₙ(t) for this modulation can be rescaled to:

$${}^{2} {S}_{n}^{′} ( t ) = {R}_{n} \times {}^{2} {S}_{n} ( t ) \qquad ( 4 )$$

where ²S′ₙ is the rescaled ²D chromatogram.

Additional eluent data is generated from the scaled second eluent data at 36 using interpolation. More specifically, Step 2B interpolates more ²D chromatograms along the ¹D time axis using the rescaled ²D slices (²S′ₙ) obtained from Step 2A. As illustrated in FIG. 2B, these rescaled ²D chromatograms are depicted on the major grids with a time interval of P_{M}. The interpolated ones are depicted on the minor grids (dashed lines), with an interval equal to data acquisition time of the first detector (¹D detector) (^{1τ=}1/¹f seconds for ¹f Hz ¹D data acquisition frequency). Note that ¹τ should be much smaller than the P_{M}, since ¹τ is generally well below 1 s (¹τ=0.01 s for example) whereas P_{M} is usually on the order of several seconds. For the sake of convenience, we use the Akima interpolation in this work as described previously, though any interpolation method should work. Note that this step is similar to Step 2 in the conventional method, except that the ²D chromatograms on the major grids that have been rescaled using first-dimensional data (¹D data) in Step 2A (²S′ₙ) are used for interpolation instead of the original modulated ones (²Sₙ).

As a result, a series of ²D chromatograms (on both major grids and minor grids), ²Eₖ(t), are obtained and each grid is ¹τ apart, where k represents the k^{th} grid that has a ¹D time stamp of k·¹τ.

The additional eluent data is then scaled at 37 to form scaled additional eluent data. With continued reference to FIG. 2B, Step 2C rescales all ²D chromatograms from Step 2B (²Eₖ(t)) based on the ¹D chromatogram. Under the similar logic of Step 2A, each ²D chromatogram on a major or minor grid is supposed to be produced by a corresponding slice of the ¹D chromatogram loaded into the ²D column. However, except those on the major grids, which are obtained from the second detector (²D detector) and have been rescaled in Step 2A, all ²D chromatograms on the minor grids are produced by interpolation in Step 2B. Therefore, we need to rescale all ²D chromatograms using the ¹D chromatogram as guidance. This way is equivalent to creating a series of virtual ²D injections with a pseudo-loading time (t_{L,pseudo}) and a pseudo-modulation time of ¹τ.

One can apply the same technique introduced in Step 2A to the ²D chromatograms on the minor grids.

$${}^{1} {A}_{k} = {\int }_{{t}_{k}}^{{t}_{k} + {t}_{L , pseudo}} {}^{1} S ( t ) dt , \qquad ( 5 )$$

where t_{r,k}=k·¹τ, is the k^{th} grid (major and minor grids are counted together).

$${}^{2} {A}_{k} = {\int }_{0}^{{P}_{M}} {}^{2} {E}_{k} ( t ) dt . \qquad ( 6 )$$

Note that Eq. (6) is the same as Eq. (2), except that ²Eₖ(t) includes the chromatograms on both major and minor grids. Accordingly, ²Eₖ(t) for the k^{th} grid can be rescaled to:

$${}^{2} {E}_{k}^{′} ( t ) = {R}_{k} \times {}^{2} {E}_{k} ( t ) , \qquad ( 7 )$$

where Rₖ is

$${R}_{k} = \frac{{}^{1} {A}_{k}}{{}^{2} {A}_{k}} . \qquad ( 8 )$$

For pneumatic modulators (duty cycle<<1), where generally t_{L}<<P_{M}<¹W_{1/2} (peak width at half maximum in ¹D), t_{L,pseudo} can be set to be t_{L}, which is the case for all examples presented below. However, for thermal modulators, the duty cycle is close or equal to 1 (i.e., t_{L}=P_{M}). One can still set t_{L,pseudo} to be t_{L}, which can still yield excellent consistency and accurate extraction of ¹tᵣ. However, the resolution (i.e., the reconstructed ¹D peak width using our method) might not be satisfactory, especially when t_{L}=P_{M} is comparable to actual ¹D peak widths or to the distance between the neighboring coeluted peaks. In this case, it is suggested setting t_{L,pseudo} to be a much smaller value to improve the resolution. Note that the major grids that have been rescaled in Step 2A may also be rescaled once more in Step 2C, since t_{L} in Eq. (1) of Step 2A may be different from t_{L,pseudo} in Eq. (5) of Step 2C.

It is worth emphasizing that for each round of rescaling (Step 2A and 2C), only the total area under the ²D chromatograms (major grids in Step 2A, and both major and minor grids in Step 2C) are changed. In other words, only the intensity ordinates of ²D chromatogram data points are rescaled whereas the abscissas (²D time axis) remain the same. The chromatogram profiles (e.g., the peak number, peak width, symmetry, ²tᵣ, and relative peak height among different peaks in each ²D chromatogram slice) are preserved. It is highly recommended to correct the potential issues of major grids (e.g., peak height reduced due to mass loss in the modulator) first to accurately anchor the subsequent interpolation in Step 2B. Therefore, it is not recommended to defer the rescaling in Step 2A to Step 2C; the two rescaling procedures in Step 2A and Step 2C should be carried out separately.

Step 3 is the same as Step 3 in the conventional procedure, which is to merge all as-obtained ²D chromatograms and export them as a contour plot for data visualization.

As a proof of concept, an in-house MATLAB program was used to generate the sampled Gaussian peaks in ¹D with known elution times, peak standard deviations (i.e., peak width), peak areas, and sampling intervals. The ²D peaks were also generated using Gaussian functions with different modulation frequencies, phase shifts, and different first and second detector responsivity ratios. 1D-to2D loading periodically starts at φ+P_{M}×n, (n=0, 1, 2, 3, . . . ), in which φ (<P_{M}), is the phase shift within the modulation period P_{M}. The elution time along ¹D and ²D was arbitrarily chosen and does not affect the conclusion. The features of the generated peaks are discussed below.

Experimental chromatograms were generated on a portable comprehensive ²D μGC system constructed in-house, which consisted of a DB-1 ms commercial column from Agilent J&W (non-polar, length 10 m, i.d. 250 μm, film thickness 0.25 μm, P/N: 122-0162), a WAX coated ²D microfabricated column (polar, length 0.5 m, cross section: 250 μm×250 μm), a microfabricated flow-restricted pneumatic modulator, a helium cartridge (for carrier gas), and two flow-through μPIDs at the outlets of the first detector and the second detector, respectively. A breath sample from a lab member was collected as the model system. During the chromatographic separation, the helium flow rate was 2 mL/min in the first separation column, which was kept at 25° C. for 2 min, then first ramped to 80° C. at a rate of 10° C./min, next ramped to 120° C. at a rate of 40° C./min. The operation on the sampling and first column separation was the same as reported in previous works. The pneumatic modulation and ²D separation were the same as in the ²D μGC system described by X. Huang, M. W. h. Li, W. Zang, X. Huang, A. D. Sivakumar, R. Sharma, and X. Fan, in “Portable comprehensive two-dimensional micro-gas chromatography using an integrated flow-restricted pneumatic modulator,” Microsystems & Nanoengineering 8, 115 (2022).

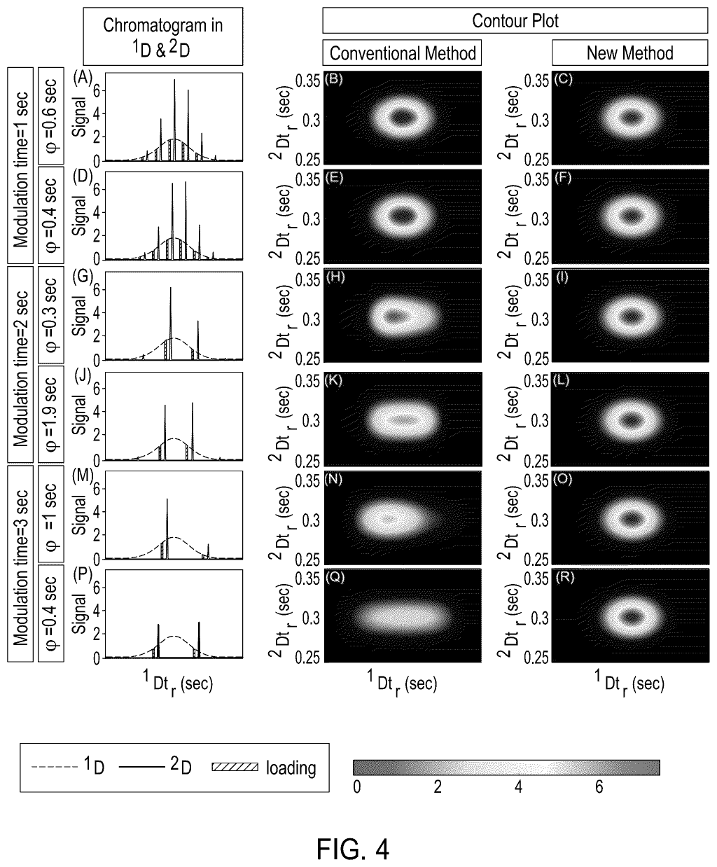

In the left panel of FIG. 4, different ²D chromatograms (solid lines) with varied modulation times (1s, 2s, and 3s) and phase shifts were generated for the same ¹D peak (dashed lines) using artificial data. The reconstructed contour plots using the conventional and the proposed first-dimension-guided differential scaling method are shown in the middle panel and the right panel, respectively. The detailed features (symmetry level, ¹D retention time tᵣ, ¹D, peak volume, and half peak width W_{1/2}) of each reconstructed peak in the ²D contour plots are summarized in Table 1.

TABLE 1
Features (symmetry level, ¹D retention time, peak volume, and peak width) of reconstructed
contour plots corresponding to the artificially generated peaks with different modulation times
P_{M} and phase shifts φ, where t_{r, 1D}: ¹D retention time at the peak apex; Peak volume: volume
under a peak in the contour plot; and W_{1/2}: peak width at half maximum of the ¹D
projection of the peak in the contour plot.

| P_{M} | Φ | Symmetry level | | t_{r, 1D} (sec) | | Peak volume | | W_{1/2}(sec) | |
|---|---|---|---|---|---|---|---|---|---|
| (sec) | (sec) | Conv. | New | Conv. | New | Conv. | New | Conv. | New |
| 1 | 0.6 | lightly asymmetrical (L) | highly | 34.93 | 35 | 0.758 | 0.7 | 2.63 | 2.6 |
| | 0.4 | Symmetrical | symmetrical | 35.01 | | 0.758 | | 2.62 | |
| | 0.2 | lightly asymmetrical (R) | | 35.07 | | 0.758 | | 2.64 | |
| | 0.9 | Symmetrical | | 34.99 | | 0.758 | | 2.67 | |
| 2 | 0.3 | highly asymmetrical (L) | | 34.35 | | 0.752 | | 3.23 | |
| | 1.9 | Symmetrical | | 35.07 | | 0.750 | | 3.72 | |
| | 1.3 | highly asymmetrical (R) | | 35.40 | | 0.755 | | 2.67 | |
| | 0.9 | Symmetrical | | 34.97 | | 0.757 | | 2.47 | |
| 3 | 1 | highly asymmetrical (L) | | 34.05 | | 0.715 | | 3.47 | |
| | 0.4 | Symmetrical | | 35.19 | | 0.649 | | 5.46 | |
| | 2.8 | highly asymmetrical (R) | | 35.89 | | 0.726 | | 3.40 | |
| | 1.9 | Symmetrical | | 34.97 | | 0.856 | | 3.08 | |

In FIG. 4, a symmetric Gaussian peak in ¹D is modulated and part of the peak is sent to ²D. For each modulation time, two ²D chromatograms with different phase shifts are presented, one with in-phase modulation (φ=0.6 s for P_{M}=1s, 0.3s for P_{M}=2s, and 1s for P_{M}=3s) the other with out-of-phase modulation (φ=0.4s for P_{M}=1s, 1.9s for P_{M}=2s and 0.4 s for P_{M}=3s). “In-phase” modulation and “out-of-phase” modulation refer to the modulation time are symmetrically and asymmetrically located with respect to the ¹D peak apex. As can be seen from the contour plots using the conventional method, the in-phase modulation produces symmetric peaks while the out-of-phase modulation produces asymmetric ones. With the increased modulation time (or the decreased modulation ratio, defined as the ratio between the width of the ¹D peak to the modulation time), the reconstructed contour plot becomes less and less accurate with the reconstructed ¹D retention time (defined as the peak apex) shifted from its original apex and generally enlarged peak volumes and peak widths, as shown in FIGS. 4 and Table 1. Therefore, there is a general broadening effect as the modulation time increases by comparing the “Conv.” column to the “New” column in Table 1. Theoretically, the ¹D peak broadening can be explained by the sampling theory. In general, the longer the modulation time is (or the lower the modulation frequency is), the less accurate the reconstructed contour plot is. Using the conventional method with only ²D data inevitably introduces peak apex shift, peak broadening, and peak profile distortion, thus reducing the overall GC×GC peak capability and quantification accuracy.

In contrast, the proposed first-dimension-guided differential scaling method can obtain consistent contour plots with identical retention time, peak volume, and half peak width, as shown in FIG. 4, because they are calibrated using the same ¹D chromatogram data.

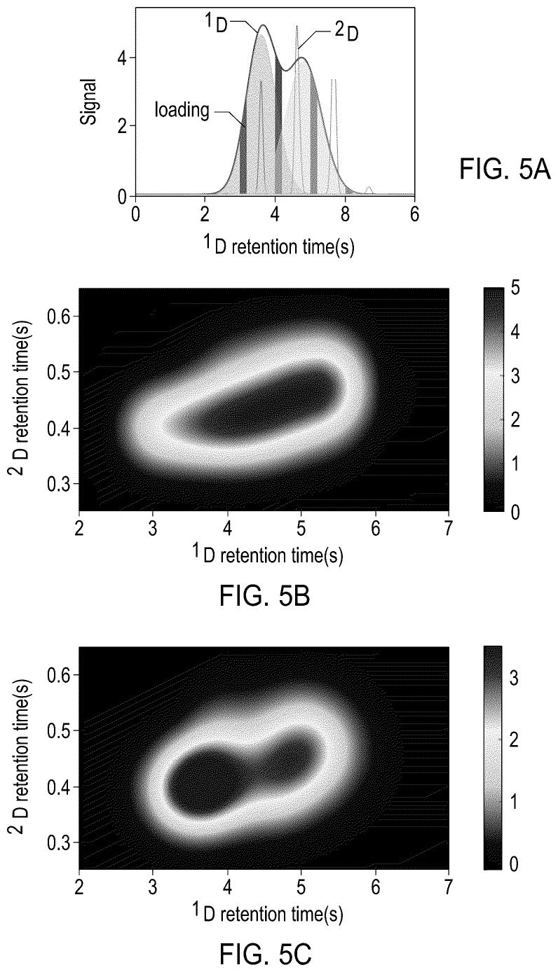

FIGS. 5A-5C present the artificially generated ¹D and ²D chromatograms with coelution, as well as the contour plots obtained from the conventional method and the proposed first-dimension-guided differential scaling method. It is shown that the reconstructed contour plot by the conventional method using the ²D chromatograms alone identified only a single peak, failing to deconvolute the coeluted peaks in the ¹D chromatogram. This is because the modulation misses sampling the peak apex or the valley in coeluted peaks, as demonstrated in FIG. 5A. To further separate coeluted peaks in the contour plots, complicated deconvolution methods/algorithms, such as the Parallel factor analysis (PARAFAC) or the Multivariate Curve Resolution-Alternating Least Squares (MCR-ALS) method, are adopted in previous studies. But they may still not able to completely resolve the coelution issue. In contrast, the contour plot in FIG. 5C using the proposed first-dimension-guided differential scaling method clearly shows two separated peaks, demonstrating the superior ability of the proposed method in handling ¹D coelution, which helps recover missed peaks and hence improve the overall GC×GC resolution or peak capacity as well as peak quantification accuracy.

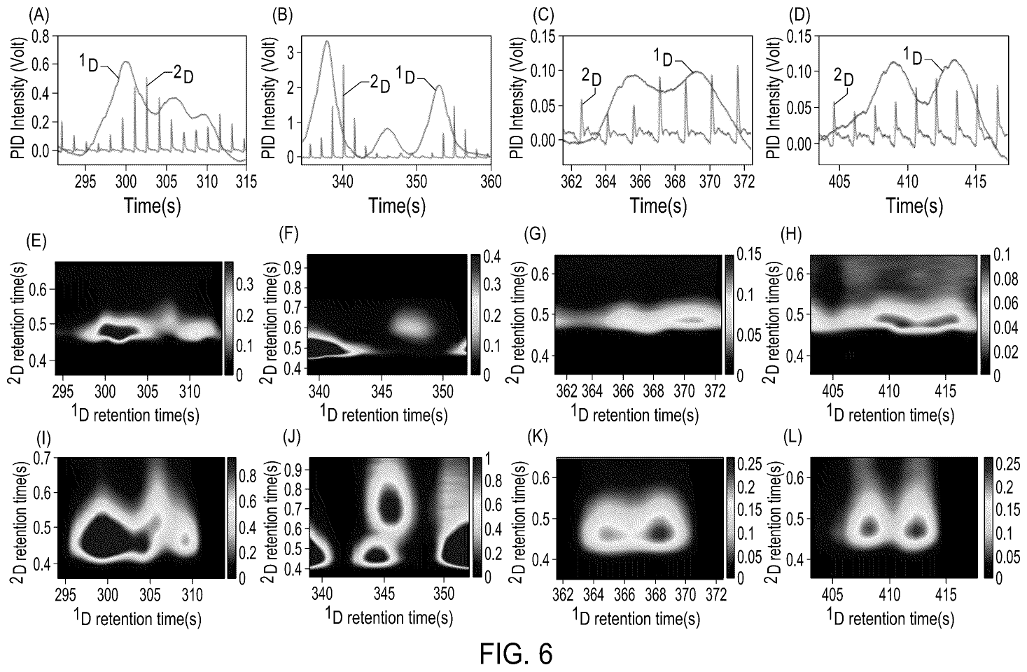

In this disclosure, an exhaled breath sample from a lab member is used as the model system. The portions of the ¹D and ²D chromatograms and the ²D contour plots of sections that show noticeable distinctions between the conventional and the proposed first-dimension-guided differential scaling methods are plotted in FIG. 6 to highlight the advantages of the proposed method. As compared to the conventional contour plots (FIGS. 6E-6H), the respective plots using the proposed first-dimension-guided differential scaling method (FIGS. 6I-6L) produce much better resolution and sharper peaks. For example, the modulations in FIGS. 6A, 6C and 6D inevitably missed the peak apexes or valleys of the partially coeluted peaks, therefore the contour plots using only ²D data in the conventional method wasted the resolutions achieved along ¹D column (hence reduced resolution). With reference to the example in FIG. 6B, the conventional contour plot shows one missing peak at ¹tᵣ=346 s, resulting from mass loss during the modulation. For example, the peak height ratio between the middle peak (¹tᵣ=346 s) and the neighboring peaks are ˜2:7 (the peak on the left, ¹tᵣ=338 s) and ˜2:5 (the peak on the right, 1tᵣ=353 s), whereas the corresponding ratios of the ²D slices after modulation decreased down to ˜1:30 and 1:20. This makes the smaller peaks between 335-352s buried in the noise, and therefore, disappear in the conventional contour plot. The proposed first-dimension-guided differential scaling method based on the corresponding slices in ¹D data was able to calibrate the ²D slices total area back, thus producing one additional distinct peak.

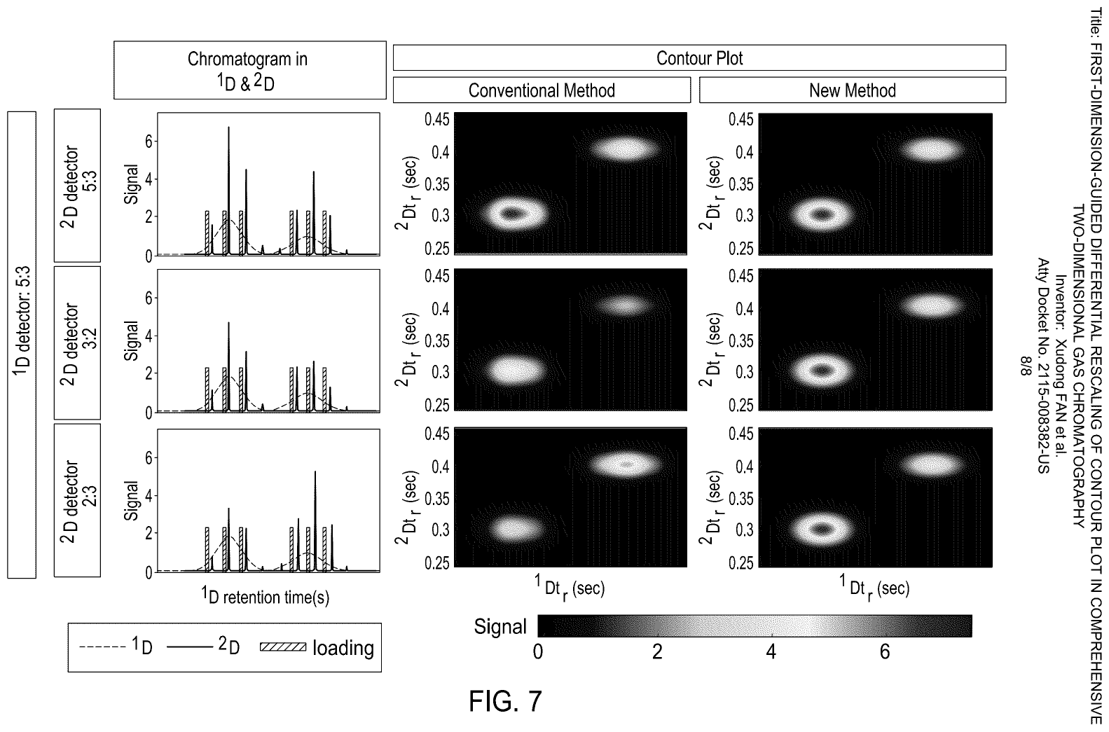

Another advantage of using the ¹D chromatogram data to calibrate the contour plot is that it makes the reconstructed contour plots immune to detector responsivity changes. Up till now (FIGS. 4 and 5), one assumes that first and second detectors are identical. In real-world scenarios, the first detector and the second detector may have different responsivities even to the same analyte (such as photoionization detector—PID, and flame ionization detector-FID). To demonstrate the robustness of the proposed method with varying responsivity ratios between the first and second detectors, three scenarios with different first and second detector responsivity ratios were generated as shown in FIG. 7. Other than the responsivity ratios, all the other peak features were kept the same for the three scenarios.

In the modeling, the first detector has a responsivity 5 and 3 to Species A and B, respectively. In the first row of FIG. 7, one can assume that the second detector is of the same type as the first detector and therefore has the responsivity of 5 and 3 to Species A and B, too. Note the absolute responsivity of the second detector changes proportionately (for example, responsivity to Species A and B increases to 10 and 6), it does not change the ²D contour plot and the results due to the ratio metric nature between the ¹D and ²D detection of the proposed method (see Eqs. (3) and (8)). This row is used as a control, where both the conventional and proposed method can see two peaks in the ²D contour plot with accurate quantification (or peak volume).

The second row simulates the scenario where the first detector and the second detector have different responsivities to Species A and B, but both ¹D and ²D have a higher responsivity to Species A than to Species B (i.e., first detector has responsivity of 5 and 3 to Species A and B, respectively, whereas the second detector has a responsivity of 3 and 2 to Species A and B, respectively). The third row simulates the scenario where the second detector has a responsivity of 2 to Species A, lower than its responsivity (=3) to Species B. In both scenarios, the conventional method yields peaks with different peak volumes and width, whereas the proposed first-dimension-guided differential scaling method yields consistent peak features. This is because all the changes in the contour plots due to the second detector ratio change are rescaled according to the original first detector responsivity ratio. The proposed method enables high versatility in detector selection. For example, one can choose PID/PID as the first and second detectors, or PID/FID as the first and second detectors.

Furthermore, the above discussion also suggests that one can afford some mass loss in the first detector. In previous works, it was assumed that the first detector is non-destructive. But now, based on the results in FIG. 7, one can use a first detector that may have some mass loss (i.e., minimally destructive detector rather than non-destructive detector). The mass loss scenario can be understood as first detector and the second detector showing different responsivities. For example, with a 10% mass loss, the absolute responsivity of the first detector and the second detector becomes 5:3 vs. 4.5:2.7 (for the first row in FIG. 7) and 5:3 vs. 2.7:1.8 (for the second row in FIG. 7). The scaling factor introduced by the mass loss can be easily corrected after rescaling with the ¹D data, as long as the mass loss is not too high to hide all ²D signals below the baseline noise level.

In conclusion, by leveraging a ¹D detector, the differential scaling algorithm can significantly improve GC×GC performance in terms of chromatographic resolution (or peak capacity), retention time accuracy, and quantification accuracy. The proposed first-dimension-guided differential scaling method exhibits high stability and consistency against the influence of modulation time and phase shift, the presence of ¹D coelution, and ¹D/²D detector responsivity changes. The method can easily be extended to other multi-dimensional instruments such as LC×LC.

The techniques described herein may be implemented by one or more computer programs executed by one or more processors of the controller 27. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for producing a two dimensional chromatogram, comprising:
measuring, by a first detector, eluent exiting a first column of a chromatography system to form first eluent data;
measuring, by a second detector, eluent exiting a second column of the chromatography system to form second eluent data, where the second column is downstream from the first column;
modulating the eluent passing from the first column to the second column at a modulation frequency;
partitioning the second eluent data into a plurality of data slices separated at time intervals according to the modulation frequency;
scaling the second eluent data to form scaled second eluent data, where the second eluent data is scaled in part using the first eluent data;
interpolating additional eluent data from the scaled second eluent data, where the additional eluent data is generated at time intervals less than time intervals specified by the modulation frequency;
scaling the additional eluent data to form scaled additional eluent data, where the additional eluent data is scaled in part using the first eluent data; and
generating a two dimensional chromatogram from the scaled second eluent data and the scaled additional eluent data.

2. The method of claim 1 wherein the second eluent data is scaled by a scaling factor and the scaling factor is the ratio of total quantity of analytes sent to the second column that is measured by the first detector during a given modulation period to total quantity of analytes measured by the second detector during the given modulation period.

3. The method of claim 1 further comprises interpolating additional eluent data from the scaled second eluent data using polynomial interpolation.

4. The method of claim 1 further comprises interpolating additional eluent data from the scaled second eluent data using Hermite interpolation.

5. The method of claim 1 wherein the additional eluent data is scaled by a scaling factor and the scaling factor is ratio of total quantity of analytes measured by the first detector during a given modulation period to total quantity of analytes measured by the second detector during the given modulation period.

6. The method of claim 1 further comprises displaying the two dimensional chromatogram on a display.

7. A chromatography system for producing a two dimensional chromatogram, comprising:
an injection port configured to receive an eluent;
a first separation column fluidly coupled to the injection port;
a first detector fluidly coupled to an outlet of the first separation column and configured to measure eluent exiting the first separation column to form first eluent data;
a second separation column fluidly coupled to and positioned downstream from the first detector;
a second detector fluidly coupled to an outlet of the second separation column and configured to measure eluent exiting the second separation column to form second eluent data;
a modulator fluidly coupled between an outlet of the first detector and an inlet of the second separation column and configured to modulate the eluent passing from the first separation column to the second separation column at a modulation frequency; and
a controller interfaced with the first detector, the second detector and the modulator.

8. The chromatography system of claim 7 wherein the controller operates to partition the second eluent data into a plurality of data slices separated at time intervals according to the modulation frequency;
scale the second eluent data to form scaled second eluent data, where the second eluent data is scaled in part using the first eluent data;
interpolate additional eluent data from the scaled second eluent data, where the additional eluent data is generated at time intervals less than time intervals specified by the modulation frequency;
scale the additional eluent data to form scaled additional eluent data, where the additional eluent data is scaled in part using the first eluent data; and
generate a two dimensional chromatogram from the scaled second eluent data and the scaled additional eluent data.

9. The chromatography system of claim 8 wherein the second eluent data is scaled by a scaling factor and the scaling factor is the ratio of total quantity of analytes sent to the second column that is measured by the first detector during a given modulation period to total quantity of analytes measured by the second detector during the given modulation period.

10. The chromatography system of claim 8 wherein the controller interpolates additional eluent data from the scaled second eluent data using polynomial interpolation.

11. The chromatography system of claim 8 wherein the controller interpolates additional eluent data from the scaled second eluent data using Hermite interpolation.

12. The chromatography system of claim 8 the additional eluent data is scaled by a scaling factor and the scaling factor is ratio of total quantity of analytes measured by the first detector during a given modulation period to total quantity of analytes measured by the second detector during the given modulation period.

13. The chromatography system of claim 8 further comprises a display interfaced with the controller to display the two dimensional chromatograms.

14. A method for producing a two dimensional chromatogram, comprising:
measuring, by a first detector, eluent exiting a first column of a chromatography system to form first eluent data;
measuring, by a second detector, eluent exiting a second column of the chromatography system to form second eluent data, where the second column is downstream from the first column;
modulating the eluent passing from the first column to the second column at a modulation frequency;
partitioning the second eluent data into a plurality of data slices separated at time intervals according to the modulation frequency;
rescaling the second eluent data in accordance with the first eluent data; and
generating a two dimensional chromatogram from the rescaled second eluent data.

15. The method of claim 14 wherein rescaling the second eluent data in accordance with the first eluent data includes
scaling the second eluent data to form scaled second eluent data, where the second eluent data is scaled in part using the first eluent data;
interpolating additional eluent data from the scaled second eluent data, where the additional eluent data is generated at time intervals less than time intervals specified by the modulation frequency; and
scaling the additional eluent data to form scaled additional eluent data, where the additional eluent data is scaled in part using the first eluent data.

16. The method of claim 15 wherein the second eluent data is scaled by a scaling factor and the scaling factor is the ratio of total quantity of analytes sent to the second column that is measured by the first detector during a given modulation period to total quantity of analytes measured by the second detector during the given modulation period.

17. The method of claim 15 wherein the additional eluent data is scaled by a scaling factor and the scaling factor is ratio of total quantity of analytes measured by the first detector during a given modulation period to total quantity of analytes measured by the second detector during the given modulation period.
